(19) United States
(12) Patent Application Publication
(10) Pub. No.: US 2008/0123892 A1
(43) Pub. Date: May 29, 2008

(54) Instant Clamp For Speech Devices

(75) Inventor: Juha Latti, Espoo (FI)

Correspondence Address: YOUNG & THOMPSON, 209 Madison Street, Suite 500, ALEXANDRIA, VA, 22314, US

(73) Assignee: SAVOX COMMUNICATIONS OY AB, ESPOO (FI)

(21) Appl. No.: 11/792,237

(22) PCT Filed: Nov. 30, 2005
(86) PCT No.: PCT/FI05/00516

§ 371 Date: Aug. 29, 2007

(30) Foreign Application Priority Data
Dec. 2, 2004 (FI) 20041564

(51) Int. Cl. H04R 19/04

(52) U.S. Cl. 381/367

(57) ABSTRACT

An instant clamp for speech devices includes an earpiece (6), an arm (8) connected to the earpiece (6), a microphone (9) connected to the arm (8) and a connecting cable (10) connected to the earpiece (6). The instant clamp includes a mounting member (1) provided with a fixing tab (3) and mounting holes (5), and a frame member (2) provided with a fixing slot (4) and locking grooves.

The invention relates to an instant clamp for speech devices as defined in the preamble of claim 1.

Various radio phones are commonly used for communication not only in fire protection and rescue operations and the defence forces, but also in industries. Due to hard working conditions persons using a radio phone may have to wear helmets, safety clothing and safety gloves as protective equipment. Nonetheless, even under strenuous conditions, a user should be able to use his/her radio phone in continuous communication with the command center, for instance. It may be difficult to hold a phone for a person wearing thick gloves or carrying the radio phone protected from water within a safety garment, for instance. In some situations, it is important to be able to use a radio phone with both hands free.

To solve the problem described above, various “hands-free devices” are commonly used. Such devices comprise e.g. a separate ear-bud/microphone headset or an earpiece and a microphone (speech device) integrated in a helmet. These devices can be connected to a radio phone e.g. via a separate key button or the radio phone can optionally be used by speech activation, so that the transmission is activated as the user starts speaking.

A separate ear-bud microphone entails low production costs, yet it is difficult to use under demanding conditions. A small ear bud tends to be detached, and usually, during transmission, a microphone used in solutions of this type collects noise from the environment besides the desired speech sound. In addition, such ear-bud microphones are not very resistant.

Speech devices integrated in a helmet are more resistant and easier to use compared to separate ear-bud microphones. In integrated solutions, the earpiece will be located at a suitable distance from the user's ear, and it will remain in position, provided that the helmet stays in position on the user's head. The microphone can also be brought closer to the user's mouth, so that less noise is collected in the transmission. However, an earpiece and a microphone integrated in a helmet involve the problem of these components being impossible to remove from the helmet. Consequently, a user who needs a radio phone will have to switch from his personal helmet to a helmet equipped with radio-phone features, or then he will have to constantly wear a helmet with an integrated earphone and microphone, even when he does not need a radio phone. Also, in case of failure of the speech device, the entire helmet will require service.

FI patent specification 100848 B discloses a solution for overcoming the integration problems mentioned above. The reference discloses a clamping assembly allowing a speech device to be fastened to a helmet and to be readily removed if necessary. This solution comprises a tab member fixed to a frame member, with the tab member pushed under the sweatband of the helmet and locked into position by bending the tab member and threading it through an opening in the frame member.

This solution involves the problems that the mounting of the speech device requires a certain time and that the helmet to which the speech device is fastened should include a sweatband. In addition, depending on the helmet design, the attachment will not always be very solid.

This invention has the purpose of providing a new instant clamp for a speech device, which is free from the prior art drawbacks mentioned above.

To achieve this, the instant clamp for speech devices in accordance with the invention is characterised by the features defined in claim 1.

The preferred embodiments of the invention are characterised by the features defined in the dependent claims.

The instant clamp of the invention enables a speech device to be fastened rapidly and easily to a helmet. When the instant clamp is used, the speech device will remain solidly attached to the helmet at a suitable distance from the user's ear.

The invention is explained below by means of examples and with reference to the accompanying drawings, in which:

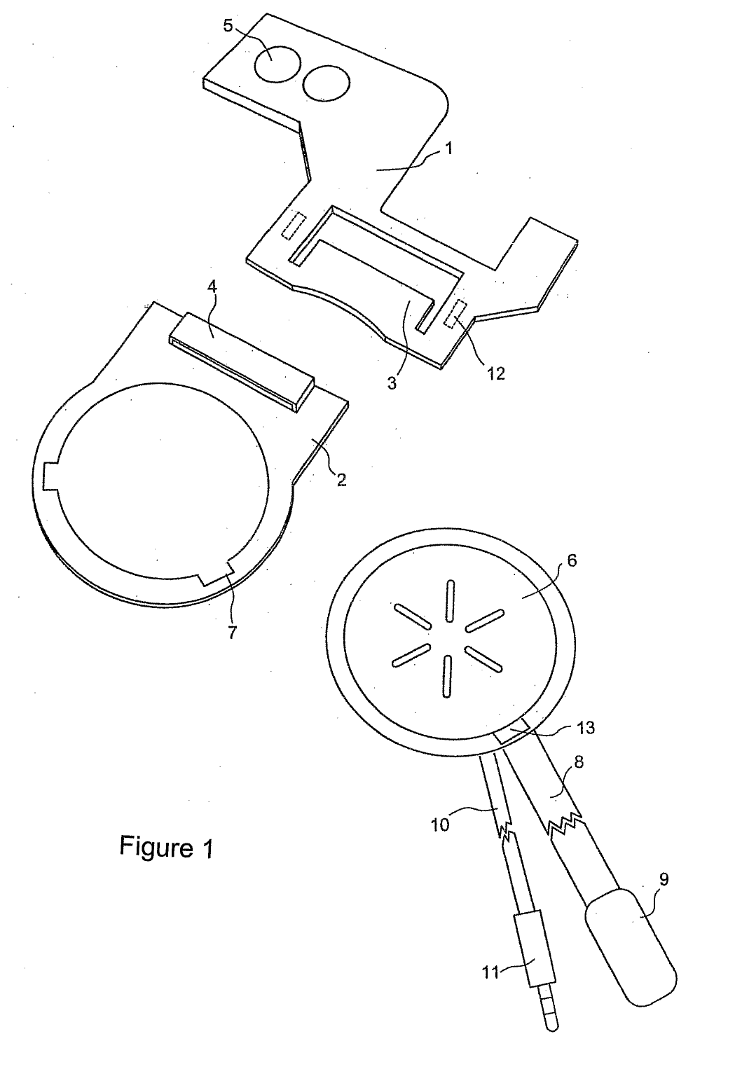

FIG. 1 shows the instant clamp for speech devices in accordance with the invention and a speech device detached from each other and

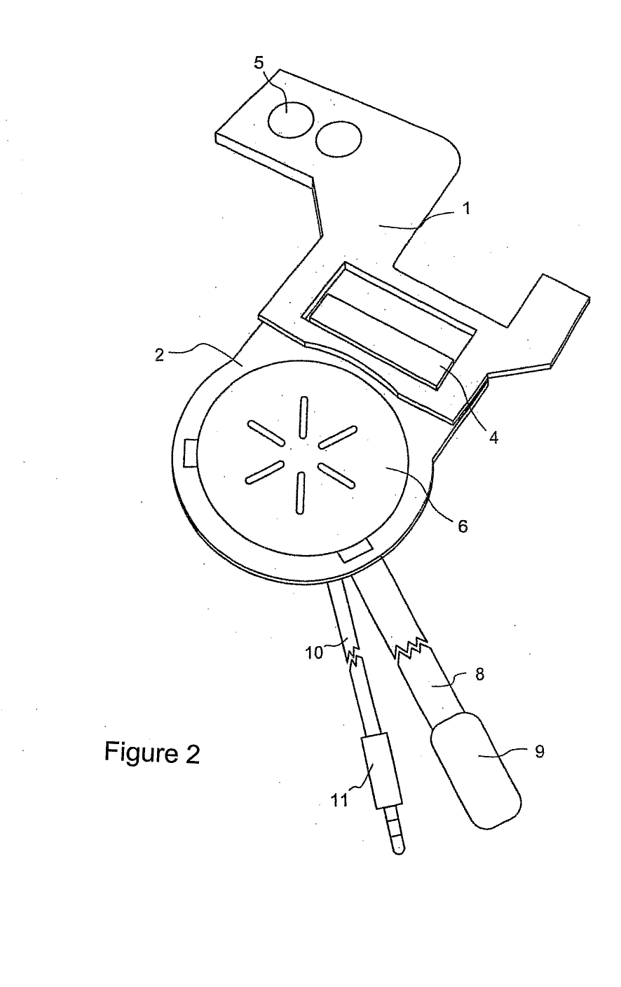

FIG. 2 shows the instant clamp for speech devices in accordance with the invention and a speech device connected to each other and

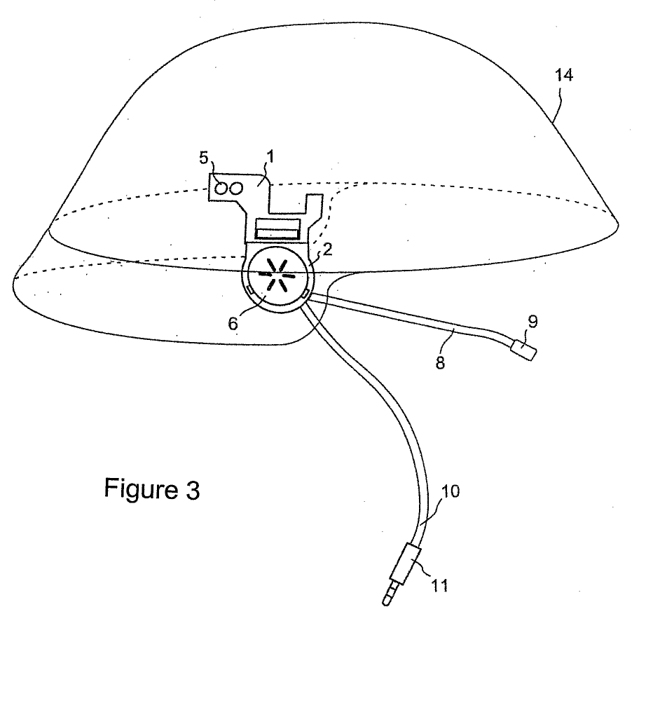

FIG. 3 shows the instant clamp for speech devices in accordance with the invention and a speech device mounted in a helmet.

The instant clamp of the invention illustrated in FIG. 1 consists of two members, a mounting member 1 and a frame member 2. The mounting member 1 has been provided with a fixing tab 3 and mounting holes 5, and the fixing tab 3 has additionally been equipped with a locking projection 12. The frame member 2, in turn, has been equipped with a fixing slot 4 and a locking recess 7.

A speech device comprises an earpiece 6, an arm 8, a microphone 9, a connecting cable 10 and a connector 11 at the end of the connecting cable 10. A locking tab 13 has additionally been formed in the earpiece 6.

When the instant clamp of the invention is used, a speech device is fastened in an opening located at the centre of the frame member 2 and having the same shape as the earpiece 6. The opening matching the shape of the earpiece 6 preferably has a size such that the earpiece 6 remains locked in the frame member 2 without separate locking means. For enhanced locking, the earpiece 6 can additionally be provided with a locking groove. Rotation of the earpiece 6 relative to the frame ember 2 is prevented by means of a locking recess 7, which the locking tab 13 provided in the earpiece engages.

The mounting member 1 is fixed to the frame of the helmet 4 by means of screws fastened through the mounting holes 5. The mounting member can be fastened either on the left-hand side or the right-hand side of the helmet 14 as necessary in each case. The exact fastening position of the mounting member is determined by the suitable distance between the earpiece and the ear of the person wearing the helmet.

The different parts of the instant clamp are connected by pressing the fixing slot 4 of the frame member 2 through the opening in the mounting member 1 while slightly bending the frame member 2 so that the upper surface of the frame member 2 contacts the lower surface of the mounting member 1. After this, the mounting member 1 and the frame member 2 are glidingly shifted relative to each other so that the fixing tab 3 of the mounting member 1 is inserted into the fixing slot 4, the members 1, 2 being subsequently engaged in each other as shown in FIG. 2.

The edge of the earpiece 6 prevents the mounting member 1 and the frame member 2 from being dislodged from each other. When the members of the instant clamp are dismantled, the frame member 2 is slightly bent for the mounting member 1 to slide over the edge of the earpiece 6. Locking pins 12 can be added to the lower surface of the mounting member 1 to ensure the locking.

When a speech device has been fastened with the instant clamp to the helmet 14, the user can adjust the microphone 9 to a suitable distance from his mouth by bending and shaping the arm 8. The arm 8 is preferably made of a flexible material that can be bent while retaining its bent shape after the bending. For use of the speech device, the connector 11 at the end of the connecting cable 10 is connected either directly to the radio phone or to a separate key button.

When a speech device is switched from left-hand to right-hand use, for instance, the earpiece 6 is first detached from the frame member 2. After this, the mutual position of the frame member 2 and the speech device is reversed relative to the left-hand mounting, and the earpiece 6 is fastened in the frame member 2 again. Accordingly, the mounting member 1 is mounted in the helmet 14 as a reversed image compared to the left-hand mounting.

To facilitate the use of instant clamps, instant clamps can be fastened in advance to the speech devices with a view to left-hand and right-hand mounting. In this manner, when the speech device is mounted for a user using left-hand or right-hand mounting, it does not have to be detached from the instant clamp.

It is obvious to those skilled in the art that the invention is not restricted to the description above, but may vary within the scope of the following claims.

1-5. (canceled)

6. An instant clamp for speech devices, where the speech device comprises an earpiece (6), an arm (8) connected to the earpiece (6), a microphone (9) connected to the arm (8) and a connecting cable (10) connected to the earpiece (6); the instant clamp comprises
a mounting member (1) provided with a fixing tab (3) and mounting holes (5) and
a frame member (2) provided with a fixing slot (4) and locking grooves (7)
characterised in that
the mounting member (1) and the frame member (2) are connected by pressing the fixing slot (4) of the frame member (2) through the opening in the mounting member (1) and then the mounting member (1) and the frame member (2) are shifted relative to each other so that the fixing tab (3) of the mounting member (1) is inserted into the fixing slot (4);
an edge of the earpiece (6) when installed prevents the mounting member (1) and the frame member (2) from being dislodged from each other.

7. An instant clamp for speech devices as defined in claim 6, characterised in that the fixing tab (3) has been provided with locking pins (12) for locking the mounting member (1) and the frame member (2) to each other.

8. An instant clamp for speech devices as defined in claim 6, characterised in that the mounting member (1) comprises mounting holes (5) for mounting the instant clamp in a helmet (14).

9. An instant clamp for speech devices as defined in claim 6, characterised in that the frame member (2) has been provided with an opening matching the shape of the earpiece for fastening of the earpiece (6) to the frame member (2).

10. An instant clamp for speech devices as defined in claim 6, characterised in that the frame member (2) has been provided with a locking recess (7) for preventing rotation of the earpiece (6).

11. An instant clamp for speech devices as defined in claim 7, characterised in that the mounting member (1) comprises mounting holes (5) for mounting the instant clamp in a helmet (14).

12. An instant clamp for speech devices as defined in claim 7, characterised in that the frame member (2) has been provided with an opening matching the shape of the earpiece for fastening of the earpiece (6) to the frame member (2).

13. An instant clamp for speech devices as defined in claim 8, characterised in that the frame member (2) has been provided with an opening matching the shape of the earpiece for fastening of the earpiece (6) to the frame member (2).

14. An instant clamp for speech devices as defined in claim 7, characterised in that the frame member (2) has been provided with a locking recess (7) for preventing rotation of the earpiece (6).

15. An instant clamp for speech devices as defined in claim 8, characterised in that the frame member (2) has been provided with a locking recess (7) for preventing rotation of the earpiece (6).

16. An instant clamp for speech devices as defined in claim 9, characterised in that the frame member (2) has been provided with a locking recess (7) for preventing rotation of the earpiece (6).
